(19) United States
(12) Patent Application Publication
(10) Pub. No.: US 2012/0056561 A1
(43) Pub. Date: Mar. 8, 2012

(54) BACKLIGHT APPARATUS, DISPLAY APPARATUS AND LIGHTING APPARATUS

(75) Inventor: Takeshi ADACHI, Saitama (JP)

(73) Assignees: ATRC CORPORATION, Saitama (JP); MITSUMI ELECTRIC CO., LTD., Tokyo (JP)

(21) Appl. No.: 13/225,627

(22) Filed: Sep. 6, 2011

(30) Foreign Application Priority Data
Sep. 7, 2010 (JP) 2010-200181

(51) Int. Cl. H05B 37/02

(52) U.S. Cl. 315/297

(57) ABSTRACT

A backlight apparatus including: a light-emitting element block on which a plurality of light-emitting elements are arranged; a plurality of driving control units each of which is configured to control driving for each of the plurality of light-emitting elements by supplying a current to the light-emitting element block; and a main control unit configured to generate a control signal for performing driving control for each of the plurality of driving control units, and to output the control signal to one of the plurality of driving control units, wherein the plurality of driving control units are connected in a daisy chain scheme, and the main control unit includes, in the control signal, identification information for identifying at least one of the plurality of driving control units and control data for performing driving control on light-emitting elements assigned to a driving control unit identified by the identification information.

### CROSS-REFERENCE TO RELATED APPLICATION

The present application is based upon and claims the benefit of priority of Japanese Patent Application No. 2010-200181, filed on Sep. 7, 2010, the entire contents of which are incorporated herein by reference.

### BACKGROUND OF THE INVENTION

1. Field of the Invention

The present invention relates to a backlight apparatus, a display apparatus including the backlight apparatus and a lighting apparatus including the backlight apparatus. More specifically, the present invention relates to a backlight apparatus, a display apparatus including the backlight apparatus and a lighting apparatus including the backlight apparatus for reducing manufacturing cost and improving tolerance against interference.

2. Description of the Related Art

LED (Light Emitting Diode) backlights are attracting attention as backlights for illuminating an optical modulation device, from the backside, such as a liquid crystal panel that is commonly used for a display apparatus for displaying an image and a video and the like.

There are several types of LED backlights. For example, in one type of LED backlights, white LEDs are arranged in order to emit white illuminating light. In another type of LED backlights, LEDs of three colors of R (red), G (green) and B (blue) are arranged so that the three colors are mixed to emit white light. Also, as to the white LED, there are several types. In one type of the white LED, fluorescent material is combined with a short-wavelength LED to obtain white light. In another type, fluorescent material is combined with a blue LED to obtain white light. Also, there is a type in which yellow fluorescent material is combined with a blue LED to obtain white light.

In addition, since a plurality of LEDs used as illumination or backlight of a display apparatus are arranged in accordance with a display size and the like, a method is known for performing driving control for a plurality of LEDs (refer to Japanese Laid-Open Patent Applications No. 2007-165336 and No. 2006-229931, for example).

Japanese Laid-Open Patent Application No. 2007-165336 discloses a backlight apparatus in which a plurality of backlight units are combined, and the backlight apparatus includes a driving unit for performing drive control for each backlight unit and a driving control unit for performing driving control for the driving unit. Japanese Laid-Open Patent Application No. 2006-229931 discloses a system in which a daisy chain is formed between a host device and client devices.

Generally, each of LED drivers for performing driving control of backlight units is connected to a main controller in a point-to-point manner. Therefore, in a case of a large-sized display, for example, the number of LED drivers increases in proportion to a screen size, so that the number of point-to-point wire connections increases by the increase of the number of LED drivers. Therefore, problems in manufacturing may occur such as increase of wiring cost, difficultly of wiring and difficulty of placement, so that variations and deterioration of quality of performance may easily occur due to variations of tolerance against interference and variations of length of wiring and the like.

Also, as shown in the patent documents, driving control for LED drivers suitable for backlight is not realized when devices are serially connected.

### SUMMARY OF THE INVENTION

Accordingly, an object of the present invention is to provide a backlight apparatus, a display apparatus and a lighting apparatus for reducing manufacturing cost and improving tolerance against interference.

According to an embodiment of the present invention, there is provided a backlight apparatus for illuminating a display unit, including:

a light-emitting element block on which a plurality of light-emitting elements are arranged at predetermined intervals;

a plurality of driving control units each of which is configured to control driving for each of the plurality of light-emitting elements by supplying a current to the light-emitting element block; and

a main control unit configured to generate a control signal for performing driving control for each of the plurality of driving control units, and to output the control signal to one of the plurality of driving control units,

wherein the plurality of driving control units are connected in a daisy chain scheme, and

the main control unit includes, in the control signal, identification information for identifying at least one of the plurality of driving control units and control data for performing driving control on light-emitting elements assigned to a driving control unit identified by the identification information.

According to another embodiment of the present invention, there is provided a display apparatus including:

a backlight apparatus;

a display unit to be illuminated by the backlight apparatus; and

a correction unit configured to correct brightness of the backlight apparatus according to an image displayed on the display unit,

the backlight apparatus comprising:

a light-emitting element block on which a plurality of light-emitting elements are arranged at predetermined intervals;

a plurality of driving control units each of which is configured to control driving for each of the plurality of light-emitting elements by supplying a current to the light-emitting element block; and

a main control unit configured to generate a control signal for performing driving control for each of the plurality of driving control units, and to output the control signal to one of the plurality of driving control units,

wherein the plurality of driving control units are connected in a daisy chain scheme, and

the main control unit includes, in the control signal, identification information for identifying at least one of the plurality of driving control units and control data for performing driving control on light-emitting elements assigned to a driving control unit identified by the identification information.

According to still another embodiment of the present invention, there is provided a lighting apparatus, including:

a light-emitting element block on which a plurality of light-emitting elements are arranged at predetermined intervals;

a plurality of driving control units each of which is configured to control driving for each of the plurality of light-emitting elements by supplying a current to the light-emitting element block; and

a main control unit configured to generate a control signal for performing driving control for each of the plurality of driving control units, and to output the control signal to one of the plurality of driving control units,

wherein the plurality of driving control units are connected in a daisy chain scheme, and

the main control unit includes, in the control signal, identification information for identifying at least one of the plurality of driving control units and control data for performing driving control on light-emitting elements assigned to a driving control unit identified by the identification information.

Other objects and further features of the present invention will be apparent from the following detailed description when read in conjunction with the accompanying drawings.

### BRIEF DESCRIPTION OF THE DRAWINGS

FIG. 1 is a diagram for explaining a schematic configuration of an LED backlight driving control unit as an example of a backlight apparatus;

FIGS. 2A-2D are diagrams for explaining control signals in the present embodiment;

FIGS. 3A-3E are diagrams for placement examples of LED backlights;

FIGS. 4A and 4B are diagrams showing examples of element blocks in the present embodiment;

FIGS. 5A and 5B are diagrams for explaining connection examples in the present embodiment;

FIG. 6 is a diagram showing an example of a functional configuration of a display apparatus including the backlight apparatus of the present embodiment; and

FIGS. 7A and 7B are diagrams for explaining other application examples of the backlight apparatus in the present embodiment.

### DESCRIPTION OF THE PREFERRED EMBODIMENTS

Preferred embodiments of the present invention are described below with reference to the accompanying drawings.

### Outline of Embodiment

According to an embodiment of the present invention, a backlight apparatus (10) for illuminating a display unit (11) is provided. The backlight apparatus (10) includes:

a light-emitting element block (12) on which a plurality of light-emitting elements are arranged at predetermined intervals;

a plurality of driving control units (13) each of which is configured to control driving for each of the plurality of light-emitting elements by supplying a current to the light-emitting element block (12); and

a main control unit (14) configured to generate a control signal for performing driving control for each of the plurality of driving control units, and to output the control signal to one of the plurality of driving control units,

wherein the plurality of driving control units (13) are connected in a daisy chain scheme, and

the main control unit (14) includes, in the control signal, identification information for identifying at least one of the plurality of driving control units (13) and control data for performing driving control on light-emitting elements assigned to a driving control unit identified by the identification information.

According to the backlight apparatus, reduction of manufacturing cost and improvement of tolerance against interference can be realized. Also, proper driving control can be performed individually by identifying each of the driving control units that are connected in a daisy chain scheme.

In the backlight apparatus, the control data (22) may include at least one piece of information of a start, an end, a duty ratio and a current value for lighting-up of the light-emitting elements.

According to the configuration, turn-on timing and brightness level can be properly controlled for light-emitting elements.

In the backlight apparatus, the main control unit (14) may include the identification information (21) in the control signal according to a connection order of the plurality of driving control units (13) that are connected in the daisy chain scheme.

According to this configuration, each driving control unit can obtain its own identification quickly.

In the backlight apparatus, at least one of the plurality of driving control units (13) may output, to the main control unit (14), a process status of driving control or a status of assigned light-emitting elements.

According to this configuration, the main control unit can recognize status of the driving control units and the light-emitting elements quickly and accurately.

In the backlight apparatus, the process status of driving control or the status of assigned light-emitting elements may include at least one piece of information of a current value, a voltage value, a temperature, overload information, and connection break information for the light-emitting elements.

According to this configuration, the main control unit can recognize status of the light-emitting elements quickly and accurately.

In the backlight apparatus, when the driving control unit (13) that receives the control signal from the main control unit (14) detects that particular identification information identifying the driving control unit is included in the control signal, the driving control unit obtains the control data corresponding to the particular identification information, and the driving control unit generates a new control signal by deleting the particular identification information and the control data from the received control signal, and outputs the new control signal to another driving control unit connected to the driving control unit.

According to this configuration, the data amount of the control signal can be reduced, so that information can be transmitted and received efficiently.

According to another embodiment of the present invention, there is provided a display apparatus (50) including: the backlight apparatus (10); a display unit (59) to be illuminated by the backlight apparatus; and a correction unit configured to correct brightness of the backlight apparatus according to an image displayed on the display unit.

According to the display apparatus, optimal images can be provided by performing brightness correction for backlights.

The display apparatus may further include:

a block information obtaining unit (53) configured to divide each frame, included in an image signal input for displaying an image on the display unit, into blocks and to obtain image information for each of the blocks; and

a block-unit control unit (54) configured to perform control for correcting brightness of backlights for each of the blocks divided by the block information obtaining unit,

wherein the backlight apparatus (10) performs drive control of the backlights for each of the blocks based on brightness control information obtained by the block-unit control unit (54) for the display unit (59).

According to this configuration, brightness correction for backlights can be performed properly and efficiently.

The display apparatus may further include:

a backlight brightness correction unit (57) configured to perform correction on the input image signal based on the brightness control information for the backlights,

wherein the display apparatus displays an image signal obtained by the backlight brightness correction unit (57) on the display unit (59).

According to this configuration, optimal images can be displayed by correcting the image signal using brightness control information that is used for brightness correction of backlights.

According to still another embodiment of the present invention, a lighting apparatus (60) is provided. The lighting apparatus (60) includes:

a light-emitting element block on which a plurality of light-emitting elements (62) are arranged at predetermined intervals;

a plurality of driving control units (63) each of which is configured to control driving for each of the plurality of light-emitting elements by supplying a current to the light-emitting element block; and

a main control unit (64) configured to generate a control signal for performing driving control for each of the plurality of driving control units, and to output the control signal to one of the plurality of driving control units,

wherein the plurality of driving control units (63) are connected in a daisy chain scheme, and

the main control unit (64) includes, in the control signal, identification information for identifying at least one of the plurality of driving control units (63) and control data for performing driving control on light-emitting elements (62) assigned to a driving control unit identified by the identification information.

According to the lighting apparatus, reduction of manufacturing cost and improvement of tolerance against interference can be realized. Also, proper driving control can be performed individually by identifying each of the driving control units that are connected in a daisy chain scheme.

The above reference symbols are merely examples, and the present invention is not limited by the reference symbols.

In an embodiment of the present embodiment, in order to improve the problems of wiring in a backlight apparatus, the backlight apparatus is configured such that driver ICs can be driven while they are simply connected, wherein each driver IC performs driving control for light-emitting elements that emit backlight. Also, in an embodiment, in order to properly perform driving control for each driver IC, a free connection driver IC system is provided in which a main controller generates a control signal including address information and data information so that the control signal is transmitted to all of the connected driver ICs.

In the following embodiments, LED is used as an example of a light-emitting element for emitting light as backlight, and a liquid crystal display is used as an example of a display unit. But, the present invention is not limited to these embodiments. Also, the backlight apparatus of the present invention can be applied to various apparatuses such as a lighting apparatus, a digital signage, and a display of a PC (personal computer) and the like in which LEDs are used, for example. In the present embodiments, the meaning of “image signal” includes both of a signal of a moving picture (moving image) and a signal of a still image.

<Backlight Apparatus>

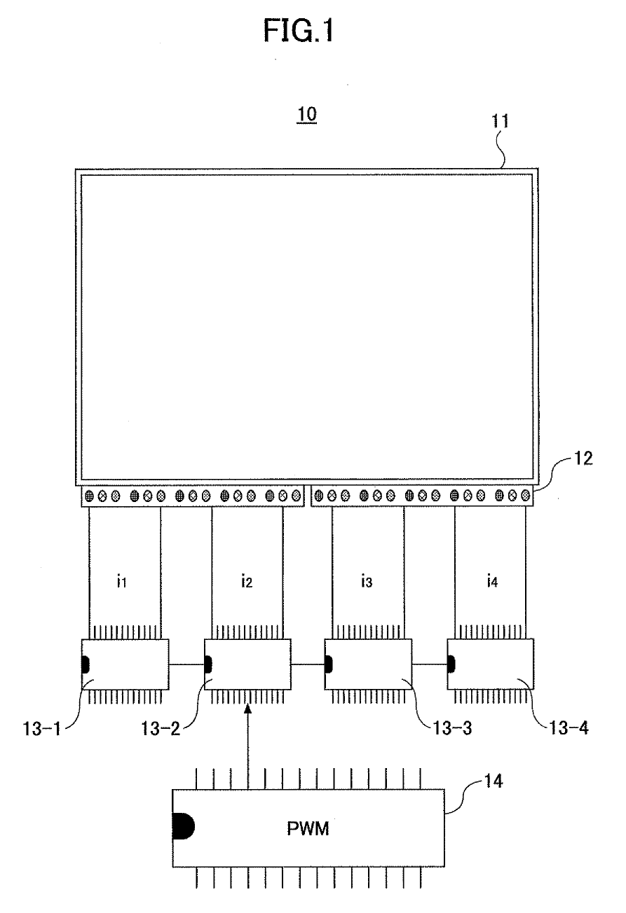

First, a schematic configuration of the backlight apparatus in the present embodiment is described with reference to a diagram. FIG. 1 is a diagram showing a schematic configuration of an LED backlight driving control unit as an example of a backlight apparatus.

As shown in FIG. 1, the LED backlight driving control unit (backlight apparatus) 10 is provided with a display unit 11, an element block 12 in which a plurality of light-emitting elements such as LEDs are arranged at predetermined intervals, driver ICs 13 as LED driving control units, and a backlight control IC (PWM (pulse width modulation)) 14 as a main controller (main control unit).

In the example shown in FIG. 1, one backlight control IC 14 performs driving control on four driver ICs 13-1-13-4. However, arrangement and the number of driver ICs are not limited to these examples. It is preferable that the light-emitting elements included in the element block 12 are connected serially such that the wiring distance becomes the shortest, the wiring cost when manufacturing is reduced and that tolerance against interference increases. But, the present invention is not limited to such a structure, and how the light-emitting elements are connected is not limited to a particular one.

In the above-mentioned configuration, the LED backlight driving control unit 10 supplies currents it i4 for driver ICs 13-1-13-4 respectively by the backlight control IC 14. Also, the LED backlight driving control unit 10 turns on LEDs, including a set of three colors of R (red), green (G) and blue (B), for example, included in the element block 12 that is connected to any of the driver ICs 13-1-13-4 with a brightness level by a current of the currents i1-i4.

The currents i1, i2, i3 and i4 flow through the driver ICs 13-1-13-4 respectively. In addition to that, an after-mentioned control signal is sent from the backlight control IC 14, and brightness is adjusted based on the current value and control data included in the control signal, so that each LED is turned on based on the adjusted condition. That is, each of the driver ICs 13-1-13-4 is adjusted by control of the backlight control IC 14 such that unevenness of brightness does not occur.

One driver IC 13 can perform driving control for a plurality of LEDs of a plurality of brightness blocks. Also, the backlight control IC 14 supplies a voltage of 5-24 V at the maximum as a low voltage to each of the driver ICs 13-1-13-4. By using a high withstand voltage driver IC as the driver IC, all LEDs can be drive-controlled even though the number of driver ICs is decreased from four driver ICs shown in FIG. 1. In this case, the backlight control IC 14 supplies a voltage of 200-300 V at the maximum to the driver IC 13.

In the present embodiment shown in FIG. 1, the driver ICs 13-1-13-4 are connected serially, which forms daisy chain connection. In this case, the backlight control IC 14 is connected to one of the driver ICs 13-1-13-4. In the example shown in FIG. 1, the backlight control IC 14 is connected to the driver IC 13-2.

Also, in the preset embodiment, in order to perform driving control for the driver ICs in the daisy chain connection, address information is set to each of the driver ICs 13-1-13-4 as identification information for identifying the driver ICs 13-1-13-4 respectively.

The backlight control IC 14 generates control data for each of the driver ICs 13-1-13-4 to perform respective driving control, so as to generate a control signal including driving control information in which the control data and the address information are combined. In addition, in the present embodiment, at least one piece of control data is set for each piece of address information.

In the present embodiment, the above-mentioned driving control information is not generated for a driver IC in charge of (assigned to) LEDs for which driving control is not performed. In the case when control data common to a plurality of pieces of address information is supplied, one piece of control data may be supplied for a plurality of pieces of address information. Accordingly, the amount of data can be reduced. A concrete example for the control signal is described later.

In the above-mentioned configuration, in the LED backlight driving control unit 10, the backlight control IC 14 performs pulse width modulation, and generates the above-mentioned control signal such that each of the driver ICs 13-1-13-4 controls ON/OFF of each assigned LED.

Since the driver ICs 13-1-13-4 are connected by the daisy chain connection, each driver IC determines whether its own address information is included in the control signal by searching the control signal, and when its own address information is included, the driver IC performs driving control for each LED that the driver IC takes charge of based on contents in control data corresponding to the address information. After receiving the control signal including the control data, the driver IC outputs the control signal to another driver IC that is connected.

When there is not the driver IC's own address information in the control signal as a result of the search, the driver IC outputs the input control signal to another driver IC that is connected without change of the control signal.

As mentioned above, each of the driver ICs 13-1-13-4 sequentially transfers the control signal generated by the backlight control IC 14, so that each of the driver ICs 13-1-13-4 can control drive timing and brightness level for each of assigned LEDs.

Also, in the present embodiment, each of the driver ICs 13-1 -1 13-4 can output a control signal to the backlight control IC 14. Accordingly, the backlight control IC 14 can recognize a process status (such as check flag indicating normal end/abnormal end) and a status of LED (normal/failure) and the like easily and accurately. In addition, the backlight control IC 14 performs feedback control based on the obtained information so as to be able to properly perform backlight driving control for each of the driver ICs 13-1-13-4.

In addition, in the present embodiment, a function such as a bypass circuit and the like can be provided. According to the bypass circuit, when a failure occurs in a part of LEDs existing in the element block 12 or when a failure occurs in a part of LEDs in an LED string in which LEDs are connected serially, the failed LED can be automatically bypassed.

According to the above-mentioned configuration, driver ICs can be easily connected so that the wiring distance can be made to be the shortest. In addition, wiring cost in manufacturing is reduced and tolerance against interference increases. Further, the size of the display panel can be easily increased. Also, there is a large merit that drivers can be easily added or deleted because of improvement of brightness of LED.

<Control Signal>

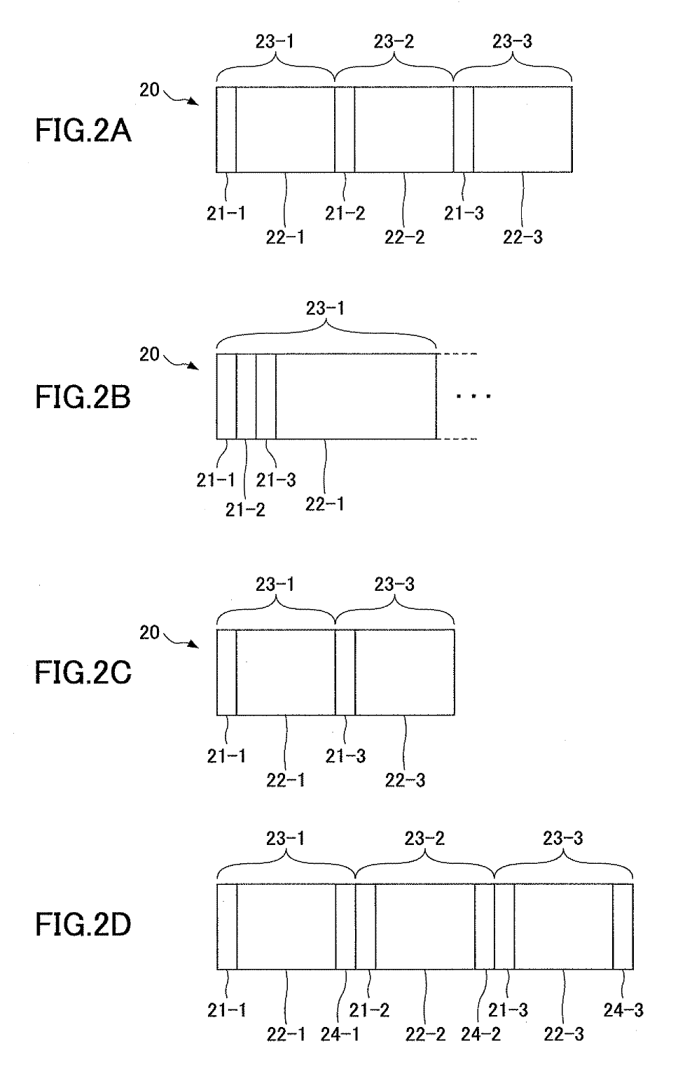

Next, concrete examples of the above-mentioned control signal are described with reference to drawings. FIGS. 2A-2D are diagrams for explaining the control signal of the present embodiment.

The control signal of the present embodiment 20 includes address information 21 and control data 22 as shown in FIG. 2A. A set of the address information 21 and the control data 22 is treated as a piece of driving control information 23. In the example of FIG. 2A, the control signal includes three pieces of driving control information 23-1-23-3. Each piece of driving control information includes identification information and control data for a driver IC of the driver ICs 13-1-13-4.

More specifically, in the example of FIG. 2A, the address information 21-1 includes identification information of the driver IC 13-1, and the control data 22-1 includes control data for the driver IC 13-1. The address information 21-2 includes identification information of the driver IC 13-2, and the control data 22-2 includes control data for the driver IC 13-2. The address information 21-3 includes identification information of the driver IC 13-4, and the control data 22-3 includes control data for the driver IC 13-4.

That is, in the present embodiment, driving control information is not generated for a driver IC that does not perform driving control. Therefore, in the case of the control signal 20 shown in FIG. 2A, since there is no control information for the driver IC 13-3, driving control for LEDs assigned to the driver IC 13-3 is not performed, and control for other driver ICs is performed.

In the present embodiment, since a plurality of driver ICs are connected by the daisy chain scheme, the control signal is transmitted between the driver ICs. Therefore, in driver ICs connected in the daisy chain scheme, when a particular driver IC is connected to another driver IC that is different from a driver IC that already obtains the control information, the particular driver IC outputs the control signal to the another driver IC.

The control data 22 of the present embodiment includes at least one piece of information of a start or a stop of lighting-up of LED in a pulse signal, a duty ratio controlling a ratio of a high section and a low section in a pulse cycle, and current value information and the like for backlight LEDs assigned to a driver IC 13 corresponding to the control data 22. In addition, in the present embodiment, for example, LED identification information may be preset for LEDs assigned to a driver IC 13, and the LED identification information of control target LEDs may be included in the control data 22 of the driver IC 13.

Each piece of the address information 21 and the control data 22 of the present embodiment may have a fixed length or may have a variable length. In the case of the fixed length, it can be ascertained whether data included in the control signal 20 at a byte position is the address information 21 or the control data 22 based on the number of bytes from the head. In the case of the variable length, the lengths of each piece of address information 21 and the control data 22 are stored in the head of the control signal 20 beforehand as header information. Accordingly, the driver IC 13 can obtain the address information 21 and the control data 22 included in the control signal 20 accurately.

In addition, in the present embodiment, identification information for identifying whether data in the control signal is the address information 21 or the control data 22 may be preset. For example, identification information of address information is set to be “A”, and identification information of control data is set to be “B”. Accordingly, the identification information is added at the head of corresponding information, so that each piece of data included in the control signal 20 can be accurately obtained.

In the case when the same control is performed for each of the driver ICs 13-1-13-4 that are connected and that are controlled by the backlight control IC 14, common address information (a high value or a low value, for example) targeting all driver ICs is stored in the area of the address information 21. When the common address information is detected, each of the driver ICs 13-1-13-4 performs driving control indicated by the control data 22 on assigned LEDs.

In the case when the same control is performed for a plurality of driver ICs of all driver ICs, driving control information 23 may be stored for each driver IC so as to generate the control signal 20 as shown in FIG. 2A. However, in this case, the same control information is included in each area of control data 22. Therefore, in the present embodiment, when the same control information is instructed for a plurality of driver ICs 13, driving control information that includes one piece of control data 22 for the driver ICs is generated.

More specifically, as shown in FIG. 2B, for example, the backlight control IC 14 generates driving control information 23 including a plurality of pieces of address information 21-1, 21-2 and 21-3 for driver ICs that are instruction targets and the same control data 22-1. In this example, the pieces of address information 21-1, 21-2 and 21-3 are stored in front of the control data 22-1. Accordingly, by generating the new driving control information for controlling a plurality of driver ICs, the amount of data of the control signal 20 transmitted and received between the connected driver ICs can be reduced so that efficient transmittal and reception of information can be realized. In the driving control information, the number of pieces of address information to be brought together is not limited to a particular number.

As an application of the above-mentioned example, by assigning a group such as A group, B group, C group or the like to each driver IC and by setting group identification information in the address information 21, driving control processing based on the same control data 22 of a group can be performed for each of driver ICs included in the group. Accordingly, driving control for a plurality of driver ICs can be performed easily, and the data amount of the control signal can be reduced.

Also, in the present embodiment, as another example for reducing the data amount of the control signal that is transmitted and received, when a driver IC detects that there is control data 22 corresponding to the driver IC's own address, the driver IC may generate a new control signal in which driving control information 23 for the driver IC is deleted from the control signal 20 so as to send the new control signal to another driver IC.

More specifically, for example, when the driver IC 13-2 shown in FIG. 1 receives a control signal 20 shown in FIG. 2A, the driver IC 13-2 searches the control signal 20 for driving control information 23-2 corresponding to the own address. When there is the driving control information 23-2, the driver IC 13-2 generates a new control signal shown in FIG. 2C in which the driving control information 23-2 is deleted, and sends the generated control signal 20 to the driver ICs 13-1 and 13-3.

As to a timing for deleting the driver IC's own driving control information 23, the driver IC may delete its own driving control information 23 when the driver IC extracts its own driving control information 23 from the control signal 20, or when driving control processing of the control data 22 included in the driving control information 23 ends normally.

Accordingly, since the data amount of the control signal can be reduced each time when the control signal passes through a driver IC 13, the delay amount can be further reduced for a driver IC (driver IC 13-4 shown in FIG. 1, for example) connected apart from the backlight control IC 14, so that the whole panel can be controlled almost at the same time.

Also, in the present embodiment, the order in which pieces of driving control information (set of address information 21 and control data 22) are stored in the control signal is not limited to a particular order. But, for example, it is preferable that the order is the same as an order in which the driver ICs are connected. The control signal is received by each of the driver ICs that are connected in the daisy chain manner in the order of connection of the driver ICs. Thus, by setting each driver IC so as to check data in the control signal from the head of the control signal, each driver IC can determine whether the control signal includes the driver IC's own address information quickly.

In addition, in the present embodiment, the pieces of driving control information 23 may be arranged and stored in the control signal 20 in ascending order or descending order with respect to the address information 21. In this case, when checking whether there is the driver IC's own address information in the control signal, the driver IC 13 checks address information from the head of the control signal in order. Then, when the address information in the control signal becomes larger than the own address information of the driver IC, the driver IC stops performing further address searching. Accordingly, an address check can be performed more quickly.

Also, in the present embodiment, each of the driver ICs 13-1-13-4 can output a signal representing a driving control process result to the backlight control IC 14. The signal representing a driving control process result may have a configuration similar to that of the control signal 20, for example. In this case, the area of the address information 21 stores preset identification information of the backlight control IC 14, and the area of the control data 22 stores at least one piece of information of a current value output to each LED, a voltage value, a temperature, overload information and break information of connection and the like as a process status of driving control of the driver IC 13 and a status of assigned LEDs. In this case, the driver IC is provided with a detection device for detecting the above-mentioned information, in which the detection device includes a current detection device, a voltage detection device, a temperature detection device, an overload information detection device and a break judgment device. Accordingly, the backlight control IC 14 can recognize status of each driver IC and LED quickly and accurately.

Further, the control signal in the present embodiment may include a check flag 24 at the end of each of driving control information 23-1-23-3 in addition to the address information 21 and the control data 22 as shown in FIG. 2D, in which the check flag 24 indicates that driving control processing indicated by the corresponding control data 22 has been performed normally.

More specifically, each driver IC 13 performs driving control processing based on the corresponding control data 22. When the processing ends normally, the driver IC sets a flag (“0”, for example) indicating a normal end in the area of the check flag 24 of the driving control information 23 corresponding to the own address information. When there is an abnormal event in the processing, the driver IC sets a flag (“1”, for example) indicating an abnormal end in the area of the check flag 24. Then, the driver IC 13 outputs the control signal to the backlight control IC 14 via driver ICs 13. Accordingly, the backlight control IC 14 can ascertain presence or absence of normal/abnormal end easily and accurately. The processing on the check flag may be performed only when an abnormal event occurs, and the processing on the check flag may not be performed when the processing is normally performed.

<Placement Example of LED Backlights>

As to placement of LED backlights of the present embodiment, the element block 12 may be placed in the lower part of the display unit 11. But, the present invention is not limited to this example. Examples of LED backlights of the present embodiment are described with reference to drawings.

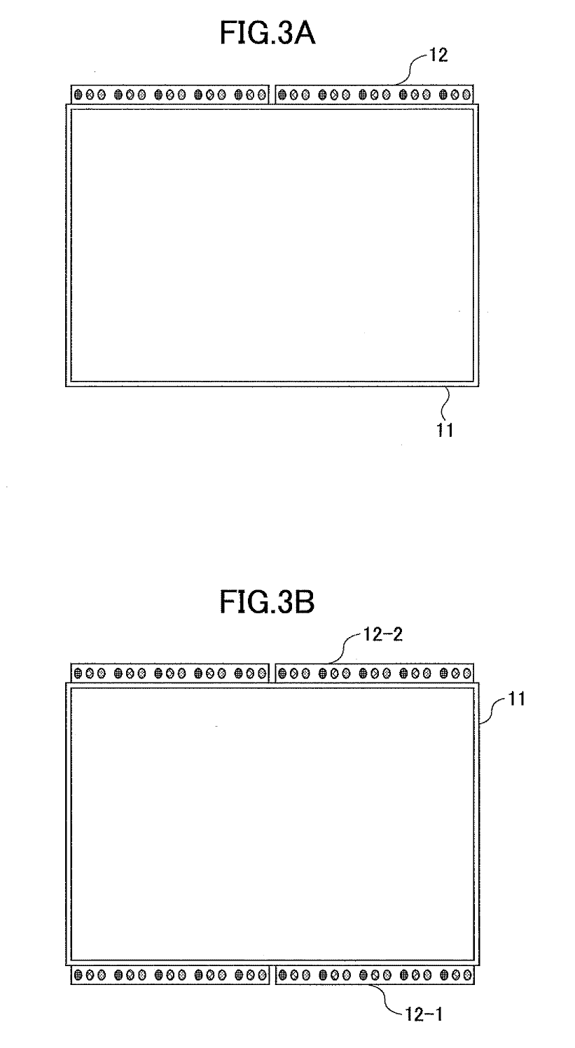

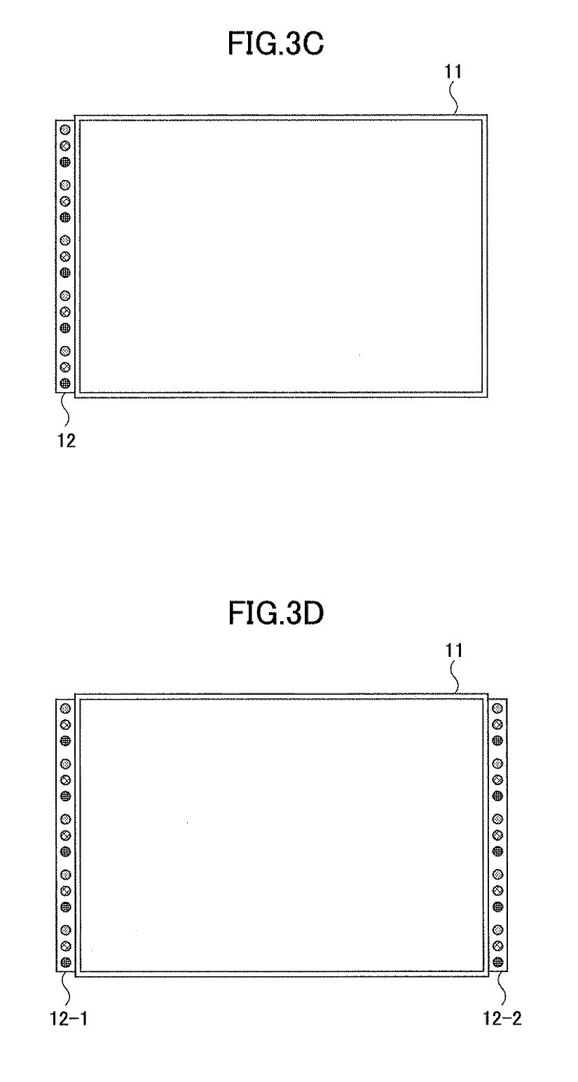

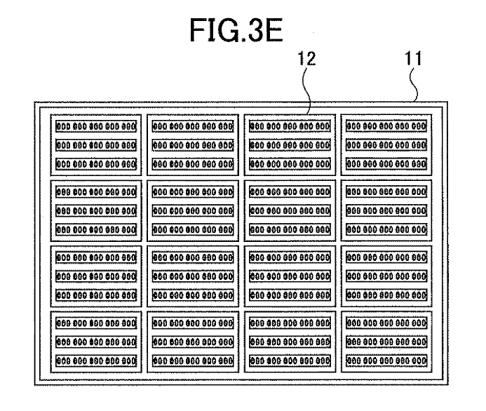

FIGS. 3A-3E are diagrams showing arrangement examples of LED backlights. As shown in FIGS. 3A-3E, the display unit 11 such as an LCD (Liquid Crystal Display) panel is provided with element blocks 12 at predetermined positions, wherein a plurality of LEDs are arranged at predetermined positions in each element block 12.

More specifically, in the example shown in FIG. 3A, an element block 12 is placed on the upper side of the display unit 11. In the example shown in FIG. 3B, element blocks 12-1 and 12-2 are placed on upper and lower sides of the display unit 11. In addition, as shown in the example of FIG. 3C, the element block 12 may be placed on one side (left or right, left in the case of FIG. 3C) of the display unit 11. Also, as shown in FIG. 3D, the element blocks 12-1 and 12-2 may be placed in both of the left and the right sides. Further, as shown in FIG. 3E, a predetermined number of element blocks 12 may be arranged on the backside of the display unit 11.

In the present invention, backlight placement is not limited to the above-mentioned examples. For example, the element blocks may be placed in upper and lower sides in addition to the left and right sides, and two or more of the above-mentioned examples may be combined.

Also, the element block 12 is divided into blocks of a size according to at least one of detection results of APL (Average Picture Level) detection, brightness histogram detection, color histogram detection and frequency histogram detection obtained from an input image signal, for example. Then, driving control is performed for LEDs arranged in each divided block by the driver IC 13. The number of element blocks that a driver IC takes charge of may be one (in units of blocks) or may be a predetermined number.

<Element Block>

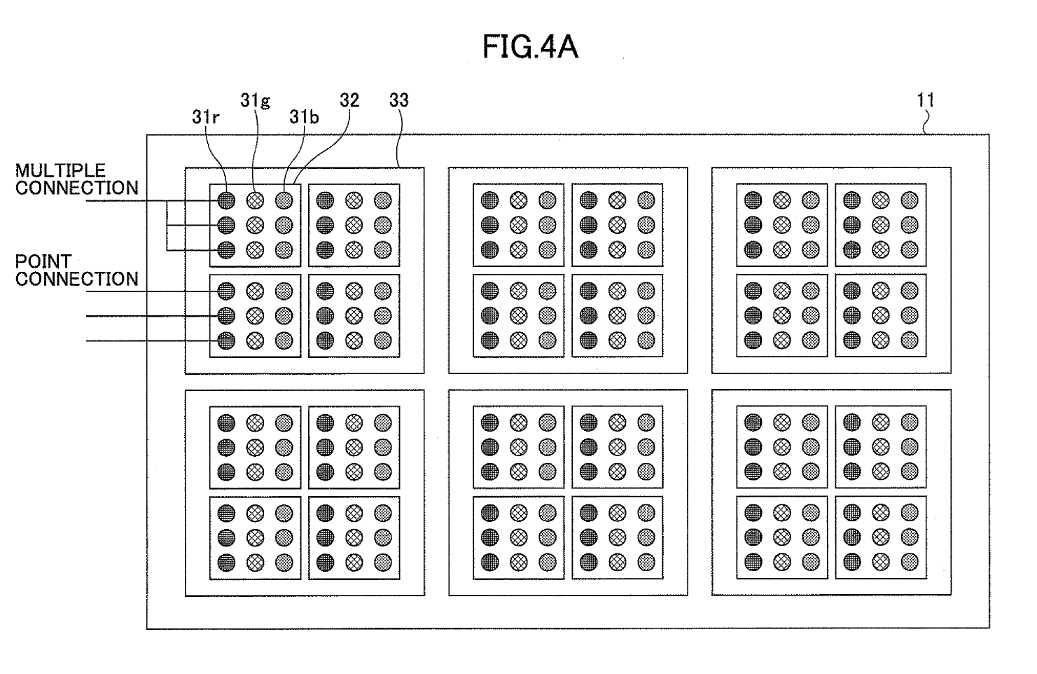

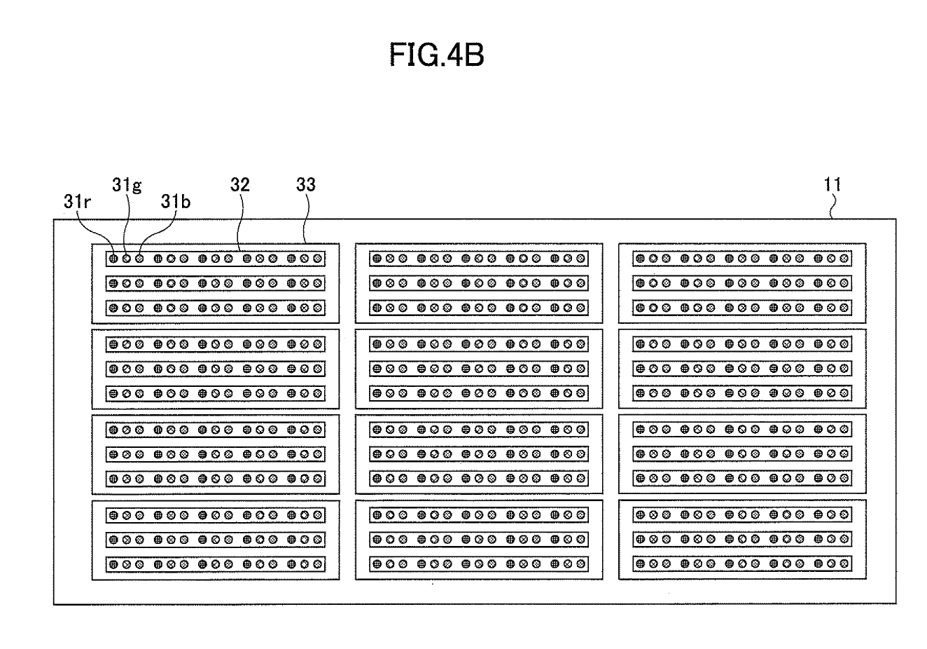

Here, examples of the element block on which a plurality of light-emitting elements (LEDs) for backlight are arranged are described with reference to diagrams. FIGS. 4A and 4B are diagrams showing examples of the element block in the present embodiment. FIGS. 4A and 4B show examples of element blocks provided on the backside of the display unit 11 as shown in FIG. 3E.

In each example of FIGS. 4A and 4B, elements 31r, 31g and 31b for R, G and B respectively are arranged on a predetermined screen display area of the display unit 11. In each example of FIGS. 4A and 4B, the elements 31r, 31g and 31b of the colors form a cell. Also, a plurality of cells forms an element block 32 (corresponding to the above-mentioned element block 12). Also, these elements are connected to the driver IC 13 by multiple connections or point connections.

In addition, a predetermined number of element blocks 32 are placed at predetermined positions, which form a brightness control block 33 for performing control of brightness correction and the like. In the present embodiment, although examples of the number and the placement of the brightness control blocks 33 are shown in FIGS. 4A and 4B, the present invention is not limited to those examples. The number and the placement may be appropriately set according to a screen size and the like of the display unit 11.

Also, these elements are connected to an assigned driver IC 13 by multiple connections or point connections. Therefore, the driver IC 13 performs brightness control for LEDs included in the element blocks 32 and the brightness control blocks 33.

<Connection Example of Driver ICs Applied to Placement of LED Backlights>

Next, connection examples of driver ICs applied to placement examples of the LED backlights are described with reference to diagrams.

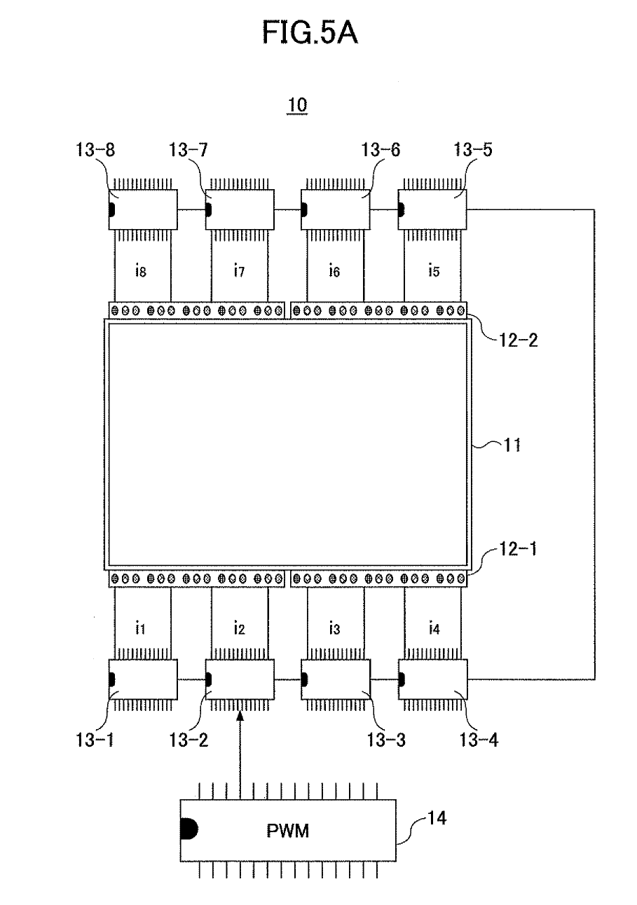

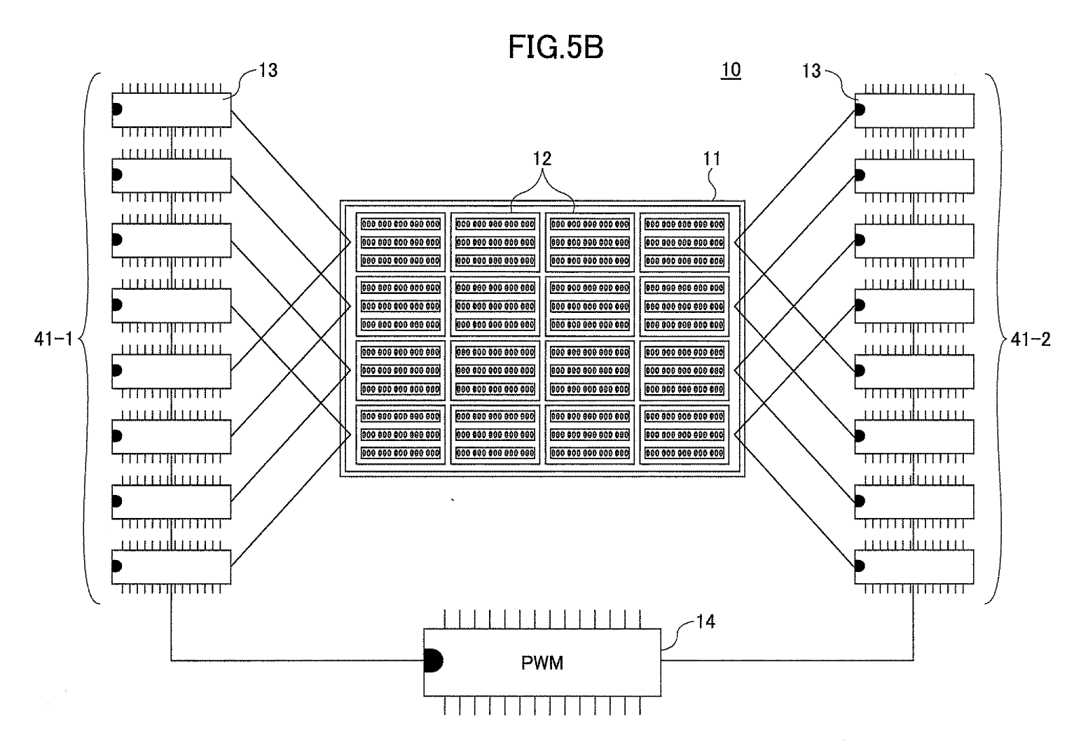

FIGS. 5A and 5B are diagrams for explaining connection examples in the present embodiment. In the example of FIG. 5A, the element blocks 12-1 and 12-2 are provided in the upper side and the lower side of a panel that is the display unit 11. Thus, in this embodiment, driver ICs 13-1-13-8 are connected in the daisy chain scheme in order to perform driving control, based on the above-mentioned daisy chain control, for turning on backlight LEDs provided in the element blocks 12-1 and 12-2. The number of driver ICs is not limited to that shown in FIG. 5A. For example, the number of the driver ICs may be arbitrarily set according to the screen size of the display unit 11 and the number of LEDs that each driver IC takes charge of.

In the example of FIG. 5A, first, the backlight control IC 14 generates the control signal of the present embodiment, and outputs the control signal to the driver IC 13-2. The driver IC 13-2 determines whether there is control data for the driver IC 13-2 using its own address information of the driver IC 13-2. When there is the control data for the driver IC 13-2, the driver IC 13-2 performs driving control for LEDs assigned to the driver IC 13-2 based on the control data. After that, the driver IC 13-2 outputs the control signal supplied from the backlight control IC 14 to each of the driver ICs 13-1 and 13-3. At this time, the driver IC 13-2 may perform processing such as deleting information corresponding to the own control data and adding the check flag as mentioned above.

After that, the driver 13-1 performs similar processing as the processing performed by the driver IC 13-2. But, since there is no driver IC connected to the driver IC 13-1 other than the driver IC 13-2, the driver IC 13-1 ends processing without outputting the control signal.

On the other hand, like the driver IC 13-2, the driver IC 13-3 determines whether there is control data for the driver IC 13-3 using the own address information of the driver IC 13-3. When there is the control data for the driver IC 13-3, the driver IC 13-3 performs driving control for LEDs assigned to the driver IC 13-3, and outputs the control signal to the driver IC 13-4. Accordingly, the control signal is finally transferred to the driver IC 13-8 in a bucket-brigade manner, in which each driver IC 13 receiving the control signal performs driving control processing for assigned LEDs.

FIG. 5B shows another example of a backlight apparatus in which the placement example of LED backlights shown in FIGS. 3E and 4B are applied. The backlight apparatus includes a backlight control IC 14, and driver IC groups 41-1 and 41-2 connected to the backlight control IC 14 respectively. In each of the driver IC groups 41-1 and 41-2, a plurality of driver ICs 13 are serially connected.

By using the scheme in which a plurality of driver ICs 13 are serially connected, unevenness of brightness or chromaticity in element blocks each having LEDs can be reduced since a particular element block can be controlled by specifying a driver IC in charge of the particular element block by using the control signal 20 including identification information of the driver IC. Therefore, correction and adjustment can be performed quickly and accurately, so that quality of products can be improved.

In the example of FIG. 5B, although each driver IC group 41 includes 8 driver ICs, the number of driver ICs included in a group is not limited to 8. Also, the number of driver IC groups 41 is not limited to 2. These numbers can be arbitrarily set according to the screen size of the display unit 11, and the number of LEDs assigned to a driver IC, for example.

Also, in the example of FIG. 5B, although the driver IC groups 41-1 and 41-2 are provided in left and right sides of the display unit 11 respectively, the present invention is not limited to the configuration example. Driver IC groups may be provided in upper and lower sides of the display unit, and may be provided in upper and lower sides and in left and right sides. The placement can be set arbitrarily according to the screen size of the display unit 11, for example.

In the example shown in FIG. 53, the address information included in the control signal sent from the backlight control IC 14 may be set to be identification information of a driver IC 13, or may be set to be identification information for identifying a group of driver ICs. In the latter case, the same control indicated by the control data can be performed to all driver ICs belonging to the group.

<Display Apparatus Including Backlight Apparatus>

Next, a configuration example of a display apparatus including the backlight apparatus (LED backlight driving control unit 10) is described with reference to a drawing.

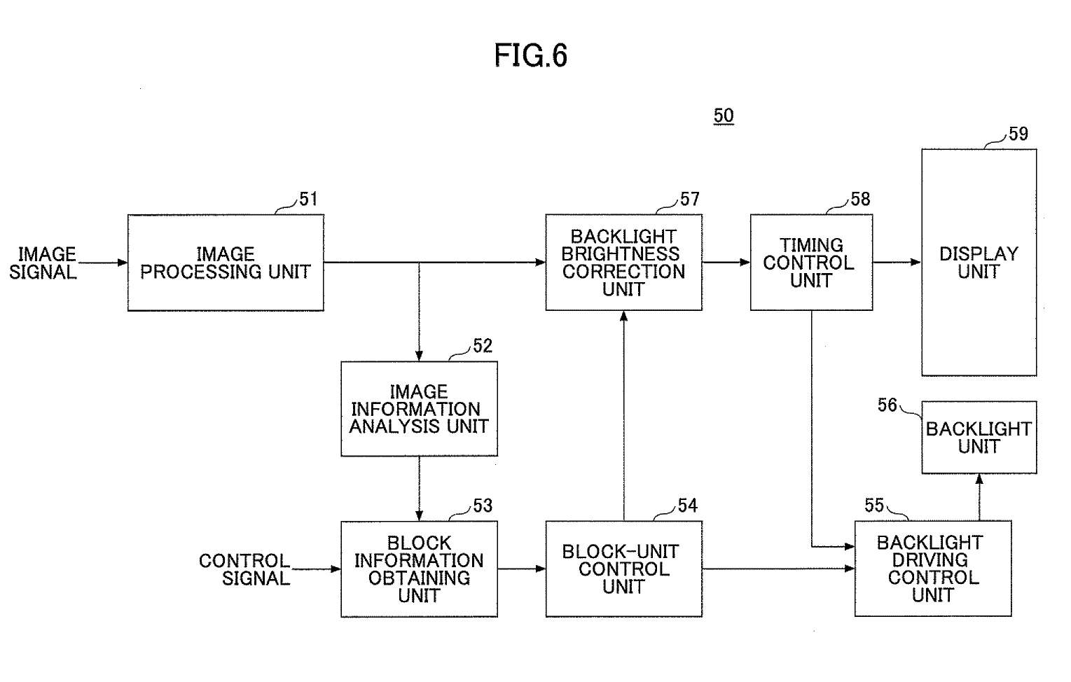

FIG. 6 is a diagram showing an example of a functional configuration of a display apparatus including the backlight apparatus of the present embodiment. The display apparatus 50 shown in FIG. 6 includes an image processing unit 51, an image information analysis unit 52, a block information obtaining unit 53, a block-unit control unit 54, a backlight driving control unit 55, a backlight unit 56, a backlight brightness correction unit 57, a timing control unit 58 and a display unit 59. In the present embodiment, the backlight apparatus corresponds to the backlight driving control unit 55 and the backlight unit 56, for example.

The image processing unit 51 decodes an input image signal in a case when the image signal is compression-coded. Also, in a case when the image signal is encrypted by scrambling and the like in a conditional access system, the image processing unit 51 decodes (descrambles) the input image signal using preset key information. That is, the image processing unit 51 properly converts the input image signal such that each unit of the latter stages can process the image signal and that an image can be displayed on the display unit 59. Also, the image processing unit 51 outputs the image signal to the image information analysis unit 52 and to the backlight brightness correction unit 57.

The image information analysis unit 52 detects, from the image signal supplied from the image processing unit 51, at least one piece of APL information, brightness histogram information, color histogram information (hue, saturation) and frequency histogram information, and the image information analysis unit 52 performs analysis on image information based on the detected information. That is, since the image information analysis unit 52 can obtain the histogram information and profile information and the like for the image (picture), brightness control for backlights corresponding to an image can be properly performed based on the information. The image information analysis unit 52 outputs an analysis result to the block information obtaining unit 53.

The block information obtaining unit 53 sets a size (the number of pixels, inches and the like) of a block unit based on the analysis result obtained by the image information analysis unit 52 and a preset control signal for the image signal. Accordingly, by setting the size of the block unit based on the image information and the like, the backlight can be controlled for each block, that is, in units of blocks, in association with image information.

As to timing for executing processing by the block information obtaining unit 53, the block information obtaining unit 53 may perform the processing when an external control signal is input. Also, the block information obtaining unit 53 may perform the processing when the analysis result is input from the image information analysis unit 52 based on preset control information, for example. The block information obtaining unit 53 outputs the obtained block information to the block-unit control unit 54.

The block-unit control unit 54 performs offset control and non-linear correction for each block based on the block information obtained by the block information obtaining unit 53 in order to control brightness of backlights for each block corresponding to the image signal. Also, the block-unit control unit 54 generates a control signal by performing pulse modulation processing by PWM (Pulse Width Modulation) in association with brightness control information of each block for the input image signal. The backlight control IC 14 is included in the block-unit control unit 54. As mentioned above, the control signal of the present embodiment includes driving control information including address information and control data for each of the driver ICs connected in the daisy chain manner to perform driving control.

In addition, the block-unit control unit 54 outputs a brightness control signal for controlling brightness of LEDs at predetermined timing to the backlight driving control unit 55 (corresponding to driver IC 13). Also, the block-unit control unit 54 outputs the brightness control information to the backlight brightness correction unit 57. Further, the block-unit control unit 54 outputs the offset control information and the non-linear correction information of each block to the backlight driving control unit 55 and the backlight brightness correction unit 57.

The backlight driving control unit 55 performs driving control for backlights corresponding to each block position by using the brightness control information, the offset control information and the non-linear correction information for each corresponding block obtained by the block-unit control unit 54, so that the backlight driving control unit 55 turns on LEDs of the backlight unit 56 at proper timing. The driver IC 13 is included in the backlight driving control unit 55. Therefore, as mentioned above, the backlight driving control unit 55 searches for the driver IC's own address information included in the control signal input for each driver IC, and when there is the driver IC's own address information, the driving control unit 55 performs driving control corresponding to the control data.

The backlight driving control unit 55 of the present embodiment outputs a control signal, to the backlight unit 56, for driving LEDs by timing control based on a clock signal from the timing control unit 58 in order to drive backlights in synchronization with the image signal output from the display unit 59 by the timing control unit 58.

Regarding the backlight unit 56, a backlight (element) includes LED (Light Emitting Diode) elements of three colors (R (red), G (green) and B (blue)) respectively, the three colors being normally provided in an LCD. Therefore, it is desirable to perform adjustment for each LED element in order to adjust each pixel. However, in this case, remarkable cost and processing time are required. Thus, in the present embodiment, processing is performed for each predetermined block. Accordingly, cost reduction and efficiency can be realized.

The backlight driving control unit 55 outputs a respective driving control signal corresponding to each block to the backlight unit 56. The backlight unit 56 turns on LEDs placed at predetermined positions of each block with proper brightness levels by performing brightness control set for each block based on the driving control signal corresponding to each block, and irradiates the screen of the display unit 59 with light of the LEDs as backlight.

The backlight brightness correction unit 57 performs brightness correction for the image signal obtained by the image processing unit 51 using drive control information for the backlights based on the brightness control information, the offset control information and the non-linear correction information obtained by the block-unit control unit 54. That is, the backlight brightness correction unit 57 performs trimming by performing reverse-correction on dimming control information of each block, and the trimmed information is fed back to the image signal side.

The backlights are placed at the backside of the display unit 59, for example, and operate for each block for brightness control. Also, operation of the backlights is brightness operation of low resolution less than the resolution of the image signal. But, according to the present embodiment, block brightness interference due to difference of brightness resolution from the image signal can be avoided, so that an optimal image that a user can easily watch can be displayed on the display screen of the display unit 59.

Also, the backlight brightness correction unit 57 performs correction of the image signal using the offset control information and the non-linear correction information, so that it becomes possible to perform control for brightness, contrast and color and the like as well as impulse control for backlights.

In the present embodiment, it is necessary that the backlight brightness correction unit 57 can properly adjust a correction amount even when information fed back to the image signal side changes according to the configuration of the brightness control block, and even when brightness transmittance and the like of the display unit 49 changes. In such a case, for example, the backlight brightness correction unit 57 can automatically adjust information to be fed back by using a result detected by a camera and the like for detecting brightness transmittance that is preset. The backlight brightness correction unit 57 outputs the image signal corrected by the above-mentioned processing to the timing control unit 58.

The timing control unit 58 performs control of time for displaying the image signal obtained by the backlight brightness correction unit 57 in conformity with the horizontal and vertical directions of the screen of the display unit 59, and generates image information displayed on the screen of the display unit 59 and outputs the generated image to the display unit 59.

In addition, in synchronization with the timing for outputting the image signal to the display unit 59, the timing control unit 58 outputs a timing control signal for turning on backlights corresponding to the image signal to the backlight driving control unit 55 in order to turn on the backlights of the backlight unit 56 in synchronization with the image displayed on the screen.

Accordingly, image output by the display unit 59 can be synchronized with backlight output of the backlight unit 56 corresponding to the image.

The display unit 59 displays image information generated by the timing control unit 58 on the screen. As the display unit 59, an LCD panel can be used, for example. But, the present invention is not limited to using the LCD panel as the display unit 59.

According to the above-mentioned configuration, in the present embodiment, backlights of the display unit 59 such as the LCD panel can be dynamically operated in conjunction with image contents. Thus, images of higher contrast can be provided. That is, according to the present embodiment, optimal backlight control can be performed according to image contents. Therefore, brightness interference to image signals that occurs when performing various dimming operation in the LCD backlight can be improved, so that the dimming operation can be improved into more optimal operation.

Also, in the present embodiment, optimal brightness control based on brightness histogram detection and the like can be realized in addition to reference brightness control processed by the conventional APL detection. For example, by performing color histogram detection, LED backlight control for RGB can be performed according to optimal white balance control and the like. That is, in the present embodiment, the backlight brightness control may be performed by using only detection results of various histograms, and also the backlight brightness control may be performed by combining the APL detection result and the histogram detection results.

<Other Application Examples of the Backlight Apparatus>

The backlight apparatus of the above-mentioned embodiment can be applied to a lighting apparatus, a digital signage, and other various displays and the like as well as the above-mentioned display apparatus such as a TV. That is, the backlight apparatus of the present embodiment can be applied to overall apparatuses that can drive light-emitting elements such as LEDs by serially connecting driver ICs. In the following, other application examples of the backlight apparatus are described with reference to drawings.

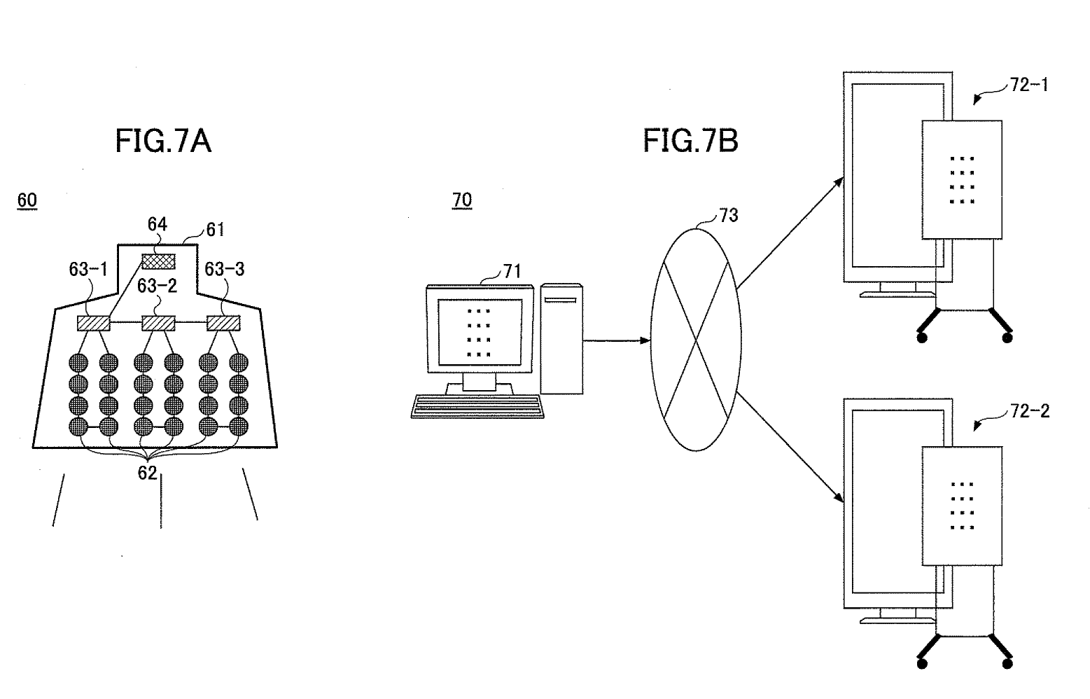

FIGS. 7A and 7B are diagrams for explaining other application examples of the backlight apparatus of the present embodiment. FIG. 7A shows an example in which the backlight apparatus of the present embodiment is applied to a lighting apparatus, and FIG. 7B shows an example in which the backlight apparatus of the present embodiment is applied to a digital signage system.

The lighting apparatus 60 shown in FIG. 7A is an LED lamp as an example. More specifically, the lighting apparatus 60 is configured such that a plurality of LEDs 62 are serially connected every predetermined number of LEDs or for each predetermined area in a lamp body 61, and serially connected LED groups are placed at predetermined positions suitable for a proper lighting direction. Each LED group may be configured to be the above-mentioned light-emitting element block.

The serially connected LED groups are connected to driver ICs (LED driving control units) 63-1-63-3 respectively as shown in FIG. 7A. Driving of LEDs is controlled by an assigned driver IC 63. The control IC 64 (main control unit) has the same function as that of the backlight control IC 14. For example, the control IC 64 generates control data for each of the driver ICs 63-1-63-3 to perform respective driving control, and generates a control signal 20 including driving control information in which the control data and the address information are combined.

As shown in FIG. 7A, the driver ICs 63-1-63-3 are connected serially. Thus, the control signal 20 output by the control IC 64 is transmitted sequentially from the driver IC 63-1 to the driver IC 63-3, so that driving control can be performed only for a predetermined driver IC. The number of driver ICs connected serially is not limited to the number of this example. The number can be set according to a size or a shape of the lighting apparatus 60, for example.

The digital signage system 70 shown in FIG. 7B is configured, for example, to include a PC (personal computer) 71 and a plurality of digital signage apparatuses 71 (digital signage apparatuses 72-1 and 72-2 in the example of FIG. 7B). The PC 71 and the digital signage apparatuses 72 are connected via a communication network 73 represented by the Internet such that transmit and receive of data are available.

In the digital signage system 70 shown in FIG. 7B, contents such as product description and a company name that are created and edited using the PC 71 by a manager are displayed and updated simultaneously on the digital signage apparatuses 72 placed in different places via the communication network 73. Each digital signage apparatus 72 uses a large-sized liquid crystal display, for example, and the backlight apparatus can be applied to such a large-sized liquid crystal display.

For example, in the digital signage apparatus 72 shown in FIG. 7B, a plurality of driver ICs are serially connected so that the control signal 20 is transmitted through all of driver ICs by a control IC. Accordingly, in the digital signage apparatus 72, each of the driver ICs that are serially connected can properly perform driving control for assigned LEDs. The backlight apparatus can be also applied to a liquid crystal display of the PC 71.

Also, according to the application examples of the backlight apparatus in the present embodiment shown in FIGS. 7A and 7B, reduction of manufacturing cost and improvement of tolerance against interference can be realized by the serial wire connection of driver ICs. In addition, by using the above-mentioned control signal, proper driving control for each driver IC can be realized.

As mentioned above, according to an embodiment of the present invention, reduction of manufacturing cost and improvement of tolerance against interference can be realized. More specifically, for connecting a main controller to a plurality of driver ICs for backlight, they are connected on a one-to-one basis between the controller and the driver IC in general. However, in this case, when there are many driver ICs, the number of one-to-one wire connections increases as the number of driver ICs increases. Therefore, variations of quality of performance and deterioration and the like easily occur due to variations of tolerance against interference and variations of length of wiring that are caused by difficulty of wiring and problems of placement and the like. On the other hand, according to an embodiment of the present invention, there is provided a free connection driver IC system that is configured to operate using driving control information (control signal) including address information and control data such that driver ICs that are simply connected can be controlled. Accordingly, a plurality of driver ICs can be connected freely and easily. Also, in an embodiment of the present invention, driving control is performed on the connected driver ICs by using the driving control information including the address information and the control information, so that light-emitting elements such as LEDs can be properly driven.

That is, according to an embodiment of the present invention, connection between driver ICs can be simplified and the number of wire connections can be reduced. Also, according to the present embodiment, since the daisy chain scheme in which the amount of wiring is small and wiring is easy is adopted, change of inch sizes (size development) of the display panel can be easily supported. Further, considering a master-slave scheme as an example, since each driver IC (IC for daisy chain) to be used in the present embodiment is provided with a master function and a slave function, a master IC that is required in a conventional technique is not necessary in the present embodiment. Also, connection lines from a main CPU to a master and the like can be arbitrarily constructed.

Also, according to an embodiment of the present invention, unevenness of LEDs (light-emitting elements) and LED blocks (element blocks) can be controlled individually and arbitrarily. Thus, unevenness of brightness and color on the overall screen can be reduced.

The present invention is not limited to the specifically disclosed embodiments, and variations and modifications may be made without departing from the scope of the present invention.

What is claimed is:

1. A backlight apparatus for illuminating a display unit, comprising:
a light-emitting element block on which a plurality of light-emitting elements are arranged at predetermined intervals;
a plurality of driving control units each of which is configured to control driving for each of the plurality of light-emitting elements by supplying a current to the light-emitting element block; and
a main control unit configured to generate a control signal for performing driving control for each of the plurality of driving control units, and to output the control signal to one of the plurality of driving control units,
wherein the plurality of driving control units are connected in a daisy chain scheme, and
the main control unit includes, in the control signal, identification information for identifying at least one of the plurality of driving control units and control data for performing driving control on light-emitting elements assigned to a driving control unit identified by the identification information.

2. The backlight apparatus as claimed in claim 1, wherein the control data includes at least one piece of information of a start, an end, a duty ratio and a current value for lighting-up of the light-emitting elements.

3. The backlight apparatus as claimed in claim 1, wherein the main control unit includes the identification information into the control signal according to a connection order of the plurality of driving control units that are connected in the daisy chain scheme.

4. The backlight apparatus as claimed in claim 1, wherein at least one of the plurality of driving control units outputs, to the main control unit, a process status of driving control or a status of assigned light-emitting elements.

5. The backlight apparatus as claimed in claim 4, wherein the process status of driving control or the status of assigned light-emitting elements includes at least one piece of information of a current value, a voltage value, a temperature, overload information, and connection break information for the light-emitting elements.

6. The backlight apparatus as claimed in claim 1, wherein, when the driving control unit that receives the control signal detects that particular identification information identifying the driving control unit is included in the control signal, the driving control unit obtains the control data corresponding to the particular identification information, and the driving control unit generates a new control signal by deleting the particular identification information and the control data from the received control signal, and outputs the new control signal to another driving control unit connected to the driving control unit.

7. A display apparatus comprising:
a backlight apparatus;
a display unit to be illuminated by the backlight apparatus; and
a correction unit configured to correct brightness of the backlight apparatus according to an image displayed on the display unit,
the backlight apparatus comprising:
a light-emitting element block on which a plurality of light-emitting elements are arranged at predetermined intervals;
a plurality of driving control units each of which is configured to control driving for each of the plurality of light-emitting elements by supplying a current to the light-emitting element block; and
a main control unit configured to generate a control signal for performing driving control for each of the plurality of driving control units, and to output the control signal to one of the plurality of driving control units,
wherein the plurality of driving control units are connected in a daisy chain scheme, and
the main control unit includes, in the control signal, identification information for identifying at least one of the plurality of driving control units and control data for performing driving control on light-emitting elements assigned to a driving control unit identified by the identification information.

8. The display apparatus as claimed in claim 7, comprising:
a block information obtaining unit configured to divide each frame, included in an image signal input for displaying an image on the display unit, into blocks and to obtain image information for each of the blocks; and
a block-unit control unit configured to perform control for correcting brightness of backlights for each of the blocks divided by the block information obtaining unit,
wherein the backlight apparatus performs drive control of the backlights for each of the blocks based on brightness control information obtained by the block-unit control unit.

9. The display apparatus as claimed in claim 8, comprising:
a backlight brightness correction unit configured to perform correction on the input image signal based on the brightness control information for the backlights,
wherein the display apparatus displays an image signal obtained by the backlight brightness correction unit on the display unit.

10. A lighting apparatus, comprising:
a light-emitting element block on which a plurality of light-emitting elements are arranged at predetermined intervals;
a plurality of driving control units each of which is configured to control driving for each of the plurality of light-emitting elements by supplying a current to the light-emitting element block; and
a main control unit configured to generate a control signal for performing driving control for each of the plurality of driving control units, and to output the control signal to one of the plurality of driving control units,
wherein the plurality of driving control units are connected in a daisy chain scheme, and
the main control unit includes, in the control signal, identification information for identifying at least one of the plurality of driving control units and control data for performing driving control on light-emitting elements assigned to a driving control unit identified by the identification information.
